(19) United States
(12) Patent Application Publication
(10) Pub. No.: US 2002/0105685 A1
(43) Pub. Date: Aug. 8, 2002

(54) Position set sturcture of scanner transmission components

(76) Inventors: Chih-Wen Huang, Hsinchu (TW); Scott Chien, PingTung (TW)

Correspondence Address: Raymond Sun, 12420 Woodhall Way, Tustin, CA, 92782, US

(21) Appl. No.: 09/769,232

(22) Filed: Jan. 24, 2001

(51) Int. Cl. H04N 1/04

(52) U.S. Cl. 358/474

(57) ABSTRACT

A kind of position set structure of scanner transmission components, wherein the holder is used to set the transmission components is molded at an adequate position of the case bottom. Besides, there are several position set axes molded on the holder and these axes have mushroom head and set seat used to locate the transmission components like gears easily and fast. Besides, on one side below the holder there is a open channel and S guard used to clip the flat cable. So, the structure originally needing several components is reduced to less components and the assembly time and difficulty is also reduced. In operation, it has easy structure, fast assembly and less cost function.

### FIELD OF THE INVENTION

This invention relates to a position set structure of scanner transmission components and particularly for the structure that is used in the scanner and directly molded in the main body of scanner to largely decrease the set components and assembly time.

### BACKGROUND OF THE INVENTION

Please refer to FIG. 1 and FIG. 2, which shows the conventional transmission device used in the scanner. As shown in FIG. 1, the pressed metal holder 14 is used as a platform to support other components; also there are punched holes on the holder 14 to locate other components. The holder 14 is fixed by screws 10 on one side of the molded case 2 bottom. There are several position set axes 11 in the aforesaid punched holes and the gears 12 are located on the set axes 11; also the motor 13 is fixed by screws 10 at the set position of the holder 14 and engages the gear.

As shown in FIG. 2, there is a upper case 7 above the scanner case 2. The motor 13 inside the case 2 rotates to carry several gears 12 to reduce speed and the gears 12 then carry the belt 6 to carry the transmission belt 4. So the optical device 3 will change its position with belt 4 along guiding rod 5 and its internal charge coupled device (CCD) can scan the image and transmit the signal to the circuit board by flat cables.

Because an independent pressed metal holder 14 is needed to support other components and other components like screws 10, set axes 11 are also needed to locate the holder 14 and gears 12, it needs more components., long assembly time and higher cost of production, stock, transportation and employees. It can't conform to the economic cost under the present situation that the scanner price and production gross profit is decreasing.

### BRIEF DESCRIPTION OF THE INVENTION

It is an object of this invention to provide a position set structure of scanner transmission components and by molded with the case to largely decrease the set components and production cost.

It's another object of this invention to provide a position set structure of scanner transmission components, whose components are easy to assemble and time saving.

To reach the aforesaid objects, the position set structure of scanner transmission components in this invention is molded at an adequate position of the case bottom. There are also several position set axes molded on the holder and the axes have mushroom head and set seat used to locate the transmission components like gears easily and fast. Besides, on one side below the holder there is a open channel and S guard used to clip the flat cable. So, the structure originally needing several components is reduced to less components and the assembly time and difficulty is also reduced. In operation, it has easy structure, fast assembly and less cost function.

To clearly understand the position set structure of scanner transmission components in this invention, below is the detailed description with figures:

### BRIED DESCRIPTION OF THE DRAWINGS

FIG. 1 is the drawing of the conventional transmission device.

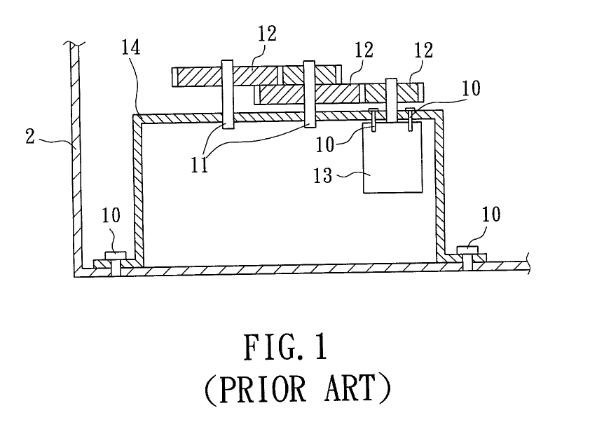

FIG. 2 is the drawing of the conventional transmission device applied on the scanner.

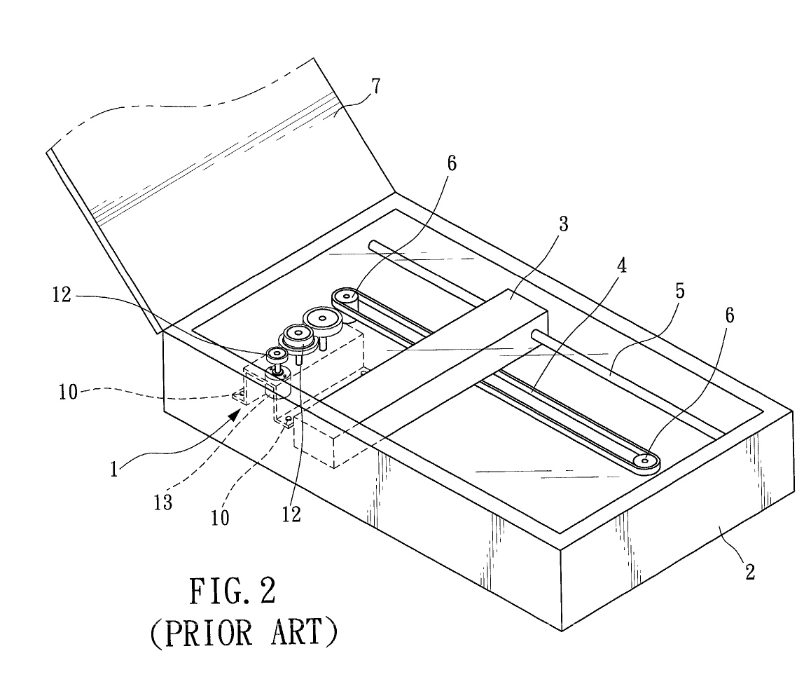

FIG. 3 is a better example of this invention.

FIG. 4 is the three-D drawing of this invention.

FIG. 5 is the B-B section drawing of FIG. 4.

FIG. 6 is the C-C section drawing of FIG. 4.

### DETAILED DESCRIPTION OF THE PREFERRED EMBODIMENTS

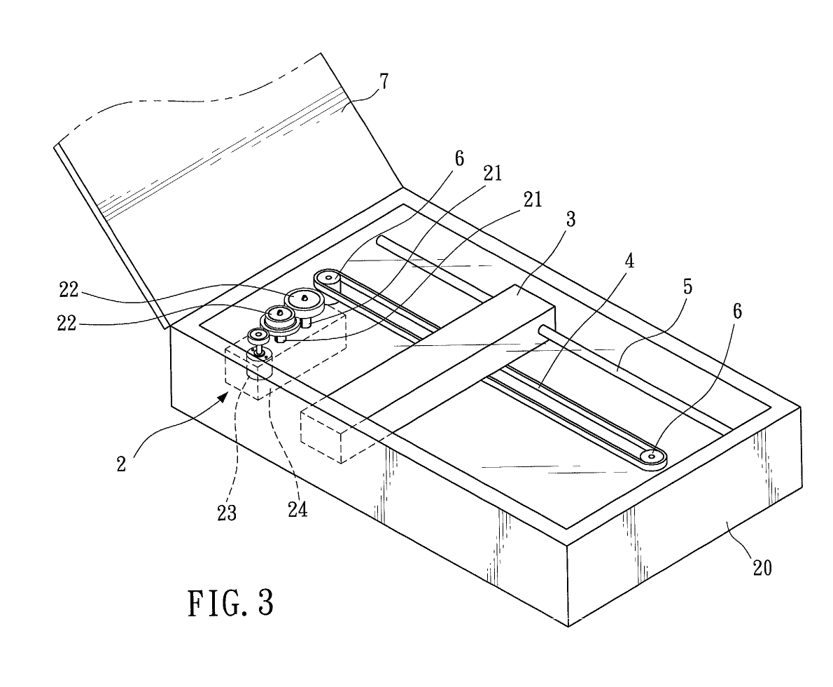

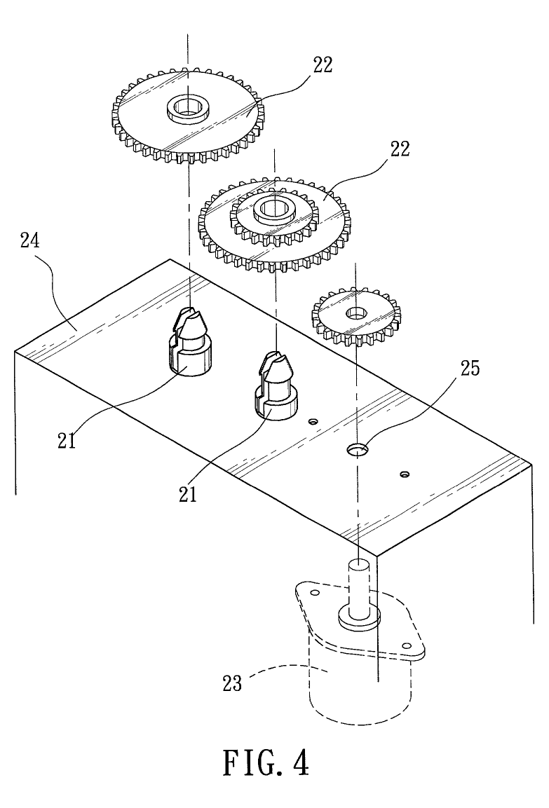

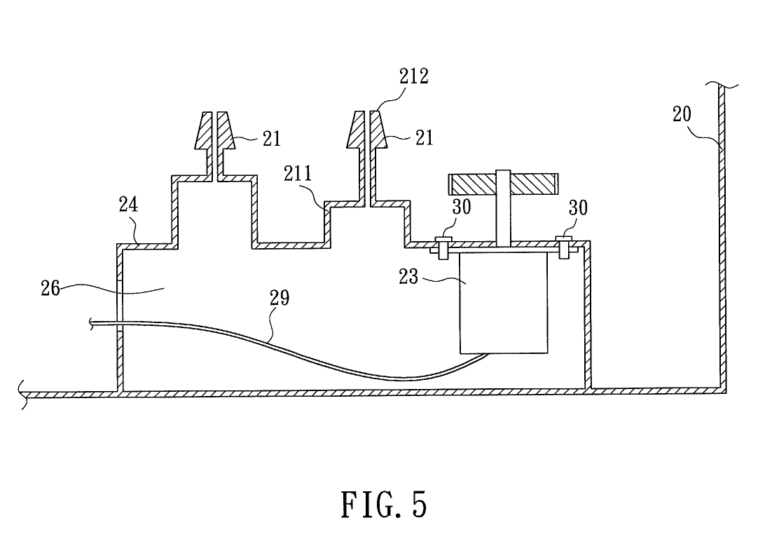

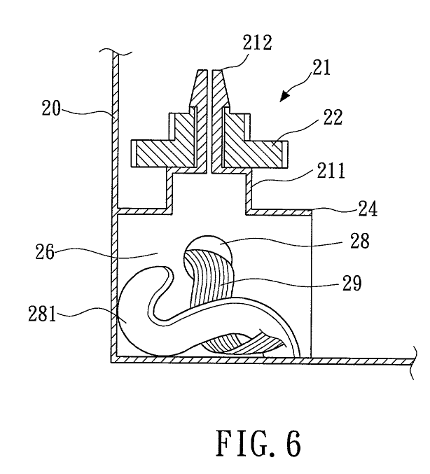

Please your examination commissioners refer to FIG. 3, which is a better example showing the position set structure of scanner transmission components. And FIG. 4 shows the detailed three-D drawing of the position set structure in this invention. FIG. 5 is the B-B section in FIG. 4. FIG. 6 is the C-C section in FIG. 4.

As shown in FIG. 3 and FIG. 4, the position set structure of scanner transmission components includes a holder 24, several position set axes 21 and several holes 25. The holder 24 is molded on the case 20. Cause the conventional scanner holder 14 is externally fixed on the case 2, it needs more components and higher cost. In this invention, the mold is well designed to protrude a platform holder 24 from shell case 20 bottom and also form a concave space 26 below holder 24. (as shown in FIG. 5).

As shown in FIG. 5, there are also several position set axes molded axes 21 on the holder 24. Each axis has left and right half structure and an adequate space between and each axis top has a mushroom head 212 with little bigger diameter than the axis diameter. The bottom has a set seat 211 with much bigger diameter. In such a situation, the axis 21 comprising left and right sides and with space between is possible to be molded (this is a conventional molding technology) and the mushroom head 212 has shrink elasticity (cause they can close to the middle space). So the gears 22 can be easily and fast mounted on the axis 21 from up to down and positioned between the mushroom head 212 and set seat 211 with rotation freedom.

Besides, the several holes 25 on the holder 24 is used to locale the motor 23 and the motor 23 is inserted from the space 26 below holder 24 (bottom of case 20) into the hole 25 and fixed on the holder 24 by several set components 30 (like screws). Each gear 22 is located on the position set axis 21 and meshes each other and the motor 23 to transmit rotation. FIG. 3 is a better example in this invention, which locates this device inside scanner and several gears 22 mesh each other to form a reduction gear set to reduce rotation speed from the motor 23. The gears 22 mesh with the belt 6 so the gear 22 rotation can carry the belt 6 to rotate to drive the optical device 3. Cause the optical device 3, belt 4, guiding rod 5, upper case 7 and other scanner components are from the conventional technology and not claimed characteristics in this invention, there will not be further description about these below.

Please your examination commissioners refer to FIG. 5 and FIG. 6. As shown in FIG. 5, several position set axes 21 are molded on the holder 24 and the holder 24 have holes 25 to locate the motor 23. Two position set components 20 are used to fix the motor 23. Cause the axes 21 are molded on the holder 24 and don't need other fastening components and the holder 24 is also molded on the case 20, it only needs two position set components 20 to fix the motor 23. It can largely decrease the axes 11 or screws 10 in conventional technology and decrease cost and assembly time. Besides, cause the motor 23 needs to be connected by flat cable 29 to a circuit board inside scanner (not shown in the figure), there is a open channel 28 in the space 26 side under holder 24 and its molded S shape guard board 281. The motor 23 connection flat cable 29 can stretch out the case 20 from case 20 inside through channel 28 under holder 24 to the space 26 and be connected to the motor 23 bottom. The S shape guard board 281 is used to clip the flat cable 29 to make it pass through the channel 28 in arrangement to avoid had influence.

According to the above description, in this invention is a kind of position set structure of scanner transmission components, wherein the holder is used to set the transmission components is molded at an adequate position of the case bottom. Besides, there are several position set axes molded on the holder and these axes have mushroom head and set seat used to locate the transmission components like gears easily and fast. Besides, on one side below the holder there is a open channel and S guard used to clip the flat cable. So there is no pressed metal holder fixed by screws on the case bottom, no axes located on the holder and no gears mounted on the axes in conventional technology. There is no disadvantage of many components and long assembly time and the needed cost of production, stock, transportation and employees in this invention is lower than the conventional technology.

Although the present invention has been described with reference to the preferred embodiments, it will be understood that the invention is not limited to the details described thereof. For example, although the preferred embodiment uses mold injection for the case, it is also can be produced by press formation. Accordingly, uniform modifications and substitutions of the disclosed embodiment of this invention are intended to be embraced within the spirit and scope of this invention.

What is claimed is:

1. A position set structure of scanner transmission components, said structure has position set holder molded at an adequate position of the case. Besides, also molded on the holder are several position set axes and at least one hole.

2. The position set structure of scanner transmission components as claimed in claim 1, wherein said hole serving as a position set of said motor.

3. The position set structure of scanner transmission components as claimed in claim 2, wherein there is a channel on one side under said holder; said motor has a connected flat cable from said channel under said holder to the case inside.

4. The position set structure of scanner transmission components as claimed in claim 3, wherein there is a S guard board located at said channel; the S guard board is molded on the holder.

5. The position set structure of scanner transmission components as claimed in claim 1, wherein said transmission components include several gears mounted on position set axes and meshed with each other for transmission.

6. The position set structure of scanner transmission components as claimed in claim 1, wherein said position set axes have left and right half structure and adequate space between.

7. The position set structure of scanner transmission components as claimed in claim 1, wherein said position set axes have mushroom head with diameter little larger than the axis diameter and set seat with much larger diameter at bottom.

8. The position set structure of scanner transmission components as claimed in claim 1, wherein said position set structure of scanner transmission components is molded on the case.

9. A position set structure of scanner transmission components, wherein the case is molded by injection and the position set structure of scanner transmission components includes:
a holder, molded on the case and serving as protruding platform from the bottom case to support the transmission components; and several position set axes, molded on surface of holder. The position set axes have mushroom head with diameter little larger than the axis diameter and set seat with much larger diameter at bottom to position the transmission components between the mushroom head and set seat with rotation freedom.

10. The position set structure of scanner transmission components as claimed in claim 9, wherein there is an exposed concave space under said holder and there is at least one hole on holder to position motor. The motor bottom is exposed to this concave space.

11. The position set structure of scanner transmission components as claimed in claim 10, wherein there is a channel on one side of said holder; said motor bottom is connected to a flat cable passing through the channel under said holder into internal case.

12. The position set structure of scanner transmission components as claimed in claim 11, wherein there is a S guard board located at said channel. The S guard board is molded on the holder to clip and position the flat cable.

13. The position set structure of scanner transmission components as claimed in claim 9, wherein said transmission components include several gears mounted on position set axes and meshed with each other for transmission.

14. The position set structure of scanner transmission components as claimed in claim 9, wherein said structure is inside scanner.

15. The position set structure of scanner transmission components as claimed in claim 9, wherein said position set axes have left and right half structure and adequate space between.
